(19) United States
(12) Patent Application Publication
(10) Pub. No.: US 2026/0274101 A1
(43) Pub. Date: Sep. 17, 2026

(54) STATION APPARATUS FOR CHARGING ROBOT AND METHOD OF CONTROLLING STATION APPARATUS

(71) Applicant: SAMSUNG ELECTRONICS CO., LTD., Suwon-si (KR)

(72) Inventors: Geunpil PARK, Suwon-si (KR); Heyunmoon BANG, Suwon-si (KR); Jinchul SHIN, Suwon-si (KR); Eunhwan LIM, Suwon-si (KR)

(73) Assignee: SAMSUNG ELECTRONICS CO., LTD., Suwon-si (KR)

(21) Appl. No.: 19/677,741

(22) Filed: May 14, 2026

Related U.S. Application Data
(63) Continuation of application No. PCT/KR2024/020598, filed on Dec. 18, 2024.

(30) Foreign Application Priority Data
Feb. 13, 2024 (KR) 10-2024-0020680
Apr. 16, 2024 (KR) 10-2024-0050971

(51) Int. Cl. B60L 53/36; B60L 53/16; H01R 13/631; H01R 13/655

(52) U.S. Cl. CPC B60L 53/36; B60L 53/16; H01R 13/631; H01R 13/655

(57) ABSTRACT

A station apparatus for charging a robot includes a frame for forming an exterior of the station apparatus, a protruding member protruding from the frame, and a charging circuit including a first charging terminal for charging the robot, and based on the robot contacting the protruding member, the protruding member protruding from the frame is retracted into the frame and reduces a traveling speed of the robot, as the protruding member is retracted into the frame, the first charging terminal protrudes from an inside of the frame to an outside of the frame, and as the first charging terminal protrudes to the outside of the frame, a contact area between the first charging terminal and a second charging terminal of the robot gradually increases.

### CROSS REFERENCE TO RELATED APPLICATIONS

This application is a continuation of International Application No. PCT/KR2024/020598, filed on December 18, 2024, which is based on and claims priority to Korean Patent Application No. 10-2024-0020680, filed on February 13, 2024, and Korean Patent Application No. 10-2024-0050971, filed on April 16, 2024, the disclosures of which are incorporated by reference herein in their entireties.

### FIELD

The present disclosure relates to a station apparatus for charging a robot and a method of controlling the station apparatus, and more particularly, to a station apparatus configured to dock with a robot such that a battery of the robot may be charged through a charging circuit of the station apparatus, and a method of controlling the station apparatus.

### BACKGROUND

A recent traveling robot, such as a cleaning robot, docks with a station apparatus and charges a battery of the robot through a charging circuit of the station apparatus.

When the traveling robot docks with the station apparatus, there exists a problem in that static electricity generated due to friction between a wheel of the traveling robot and a floor is introduced through the charging circuit and causes damage to the station apparatus.

### SUMMARY

According to an aspect of the present disclosure, a station apparatus for charging a robot according to one or more embodiments includes a frame for forming an exterior of the station apparatus, a protruding member protruding from the frame, and a charging circuit including a first charging terminal for charging the robot, and, based on the robot contacting the protruding member, the protruding member protruding from the frame is retracted into the frame and reduces a traveling speed of the robot, as the protruding member is retracted into the frame, the first charging terminal protrudes from an inside of the frame to an outside of the frame, and as the first charging terminal protrudes to the outside of the frame, a contact area between the first charging terminal and a second charging terminal of the robot gradually increases.

The station apparatus may further include at least one gear for protruding the first charging terminal to the outside of the frame as the protruding member is retracted into the frame.

The at least one gear may include a first gear rotating in a first direction as the protruding member is retracted into the frame, a second gear rotating in a second direction opposite to the first direction as the first gear rotates, and a third gear rotating in the first direction as the second gear rotates and protruding the first charging terminal to the outside of the frame.

The station apparatus may further include a first support for supporting the protruding member, and the first support may include a plurality of first grooves, and the first support may engage with the first gear through the plurality of first grooves.

The station apparatus may further include a second support for supporting the first charging terminal, and the second support may include a plurality of second grooves, and the second support may engage with the third gear through the plurality of second grooves.

The protruding member may reduce a traveling speed of the robot at a speed corresponding to a gear ratio between the first gear and the third gear.

The station apparatus may further include an elastic member for providing an elastic force for protruding the protruding member to the outside of the frame, and based on the protruding member moving in a direction compressing the elastic member, the traveling speed of the robot may be reduced by the elastic force.

The station apparatus may further include an elastic member for providing an elastic force for protruding the protruding member to the outside of the frame, and based on the robot moving away from the station apparatus, the protruding member may protrude to the outside of the frame by the elastic force.

While a contact area between the first charging terminal and the second charging terminal gradually increases, static electricity generated by friction between the robot and a floor surface may be introduced from the second charging terminal to the first charging terminal.

The station apparatus may further include a ground member for receiving static electricity introduced through the first charging terminal from the second charging terminal, and while a contact area between the first charging terminal and the second charging terminal increases, the static electricity introduced through the first charging terminal from the second charging terminal may move to the ground member.

The static electricity moved to the ground member may be discharged to the frame.

The second charging terminal may include a hole for receiving the first charging terminal, and based on the first charging terminal protruding to the outside of the frame, at least a portion of the first charging terminal may be received in the hole.

Based on an area in which the first charging terminal and the second charging terminal contact each other becoming greater than or equal to a preset value, the robot may be charged.

The first charging terminal and the second charging terminal may be electrically conductive, and the protruding member may be electrically insulating.

The station apparatus may further include memory and a processor, and the processor may be configured to receive information on a weight of the robot from the robot, identify an approach speed corresponding to the weight of the robot, and transmit information on the approach speed corresponding to the weight of the robot to the robot so that the robot approaches and docks with the station apparatus at the identified approach speed.

According to an aspect of the present disclosure, a method of controlling a station apparatus for charging a robot according to one or more embodiments comprises, based on the robot contacting a protruding member protruding from a frame of the station apparatus, retracting the protruding member into the frame to reduce a traveling speed of the robot, protruding, as the protruding member is retracted into the frame, a first charging terminal of a charging circuit from an inside of the frame to an outside of the frame, and gradually increasing, as the first charging terminal protrudes to the outside of the frame, a contact area between the first charging terminal and a second charging terminal of the robot.

According to an aspect of the present disclosure, a non-transitory computer-readable storage medium according to one or more embodiments stores one or more instructions that, when executed by at least one processor of a station apparatus for charging a robot, cause the station apparatus to perform the above-described method.

### BRIEF DESCRIPTION OF DRAWINGS

FIG. 1 is a view provided to explain a robot charging system according to one or more embodiments;

FIG. 2 is a block diagram provided to explain configuration of a station apparatus according to one or more embodiments;

FIG. 3 is a flowchart provided to explain a method in which a robot docks with a station apparatus and charges a battery according to one or more embodiments;

FIG. 4 is a view provided to explain configuration for performing docking between a station apparatus and a robot according to one or more embodiments;

FIGS. 5, 6 and 7 are views provided to explain a docking process between a station apparatus and a robot according to one or more embodiments; and

FIG. 8 is a flowchart provided to explain a method in which a station apparatus controls an approach speed of a robot according to one or more embodiments.

### DETAILED DESCRIPTION

The present disclosure may be variously modified and have several embodiments, and specific embodiments of the present disclosure are thus illustrated in the accompanying drawings and described in detail in the specification. However, it should be understood that the scope of the present disclosure are not limited to specific embodiments, and include all modifications, equivalents, and alternatives according to one or more embodiments of the present disclosure. Throughout the accompanying drawings, similar components may be denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (e.g., a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components, and these expressions are only used to distinguish one component and another component from each other, and do not limit the corresponding components.

When any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, when any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform~” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

Meanwhile, various elements and regions in the drawings are schematically illustrated. Therefore, the spirit of the present disclosure is not limited by relative sizes or intervals illustrated in the accompanying drawings.

Hereinafter, one or more embodiments of the present disclosure is described in detail with reference to the accompanying drawings so that those skilled in the art to which the present disclosure pertains may easily practice the present disclosure.

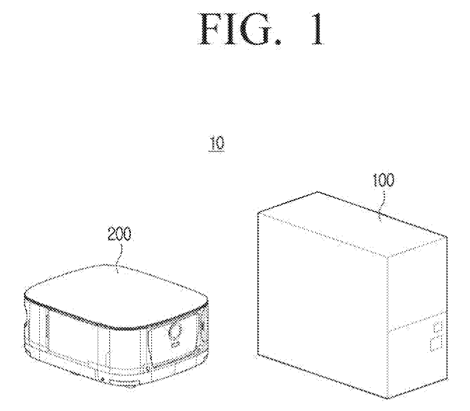

FIG. 1 is a view provided to explain a robot charging system according to one or more embodiments.

Referring to FIG. 1, a robot charging system 10 may include a station apparatus 100 and a robot 200.

The station apparatus 100 is an apparatus capable of charging a battery of the robot 200. The station apparatus 100 may include a charging circuit for charging the battery of the robot 200. The charging circuit may be also referred to as a charging assembly.

In the present disclosure, the station apparatus 100 may be replaced with terms such as a “docking station,” a “charging station,” a “charging apparatus,” or a “charger.”

The station apparatus 100 may charge the battery of the robot 200 by converting alternating current (AC) power received from an external power source (for example, household AC power) into direct current (DC) power and supplying the DC power to the robot 200.

The station apparatus 100 may be fixed at a predetermined position (for example, a position placed by a user, and may not move unless a special situation occurs (for example, when moved by a user). While the station apparatus 100 is positioned at the predetermined position and the robot 200 moves within a specific space, when an output voltage of the battery of the robot 200 approaches a minimum voltage, the robot 200 may move toward the station apparatus 100 to charge the battery based on location information of the station apparatus 100 included in a pre-stored map. The robot 200 may dock with the station apparatus 100 to charge the battery.

The station apparatus 100 may perform a charging operation for the battery of the robot 200 after detecting that the robot 200 has docked with the station apparatus 100.

The robot 200 may be a traveling robot including a traveling unit. The robot 200 may travel within a specific space (for example, a home, company, restaurant, or airport), and may perform a preset function in the specific space. For example, when the robot 200 is a cleaning robot, the robot 200 may clean a floor while moving inside a house. As another example, when the robot 200 is a serving robot, the robot 200 may serve food while moving within a restaurant.

The robot 200 may include a battery, and may perform a preset function while moving within a specific space using electrical energy stored in the battery. While the robot 200 performs the preset function while moving within the specific space, electrical energy of the battery may be consumed, and an output voltage of the battery may decrease.

When the output voltage of the battery is greater than or equal to a preset minimum voltage, the robot 200 may normally operate, and when the output voltage of the battery is less than the preset minimum voltage, the robot 200 may stop operating. Accordingly, when the output voltage approaches the minimum voltage, the robot 200 may move toward the station apparatus 100.

Meanwhile, while the robot 200 travels, static electricity caused by frictional charging between a traveling unit (for example, a wheel) of the robot 200 and a floor may be generated. In this case, the generated static electricity may be charged on a second charging terminal of the robot 200.

In addition, static electricity caused by contact electrification may be generated during a process in which a first charging terminal of the station apparatus 100 contacts the second charging terminal of the robot 200. Here, contact electrification may refer to a phenomenon generated due to contact between metals having a potential difference. In this case, the generated static electricity may be charged on the second charging terminal of the robot 200.

At this time, when the first charging terminal of the station apparatus 100 contacts the second charging terminal of the robot 200, static electricity charged on the second charging terminal of the robot 200 may be rapidly introduced to the first charging terminal of the station apparatus 100, thereby causing damage to an internal circuit of the station apparatus 100.

In order to solve the above-described problem, the station apparatus 100 according to the present disclosure may include a deceleration device for reducing a traveling speed of the robot 200. Accordingly, a speed at which the robot 200 approaches the station apparatus 100 for docking may be reduced.

In addition, as the robot 200 approaches, a charging terminal of the station apparatus 100 may gradually protrude. As the charging terminal of the station apparatus 100 gradually protrudes, a contact area between the first charging terminal and the second charging terminal may gradually increase. Accordingly, a rate at which static electricity charged on the second charging terminal is introduced to the first charging terminal may decrease, thereby solving a problem in which static electricity introduced to the station apparatus 100 damages an internal circuit.

In addition, the station apparatus 100 may include a first ground member for discharging static electricity charged on the first charging terminal to a frame of the station apparatus 100 having a potential of zero or close to zero.

Further, the robot 200 may include a second ground member for discharging static electricity charged on the second charging terminal to a frame of the robot 200 having a potential of zero or close to zero.

Accordingly, an amount of static electricity introduced to a control circuit of the station apparatus 100 through the first charging terminal 114 may be eliminated or reduced.

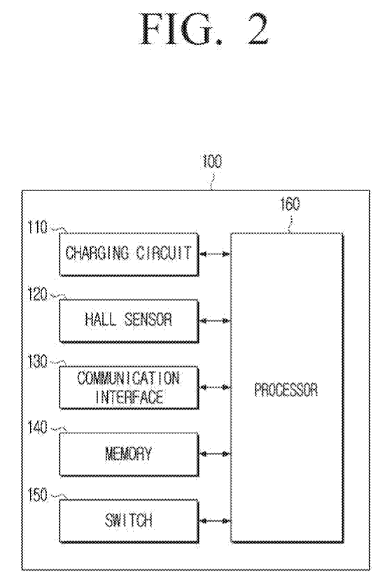

FIG. 2 is a block diagram provided to explain configuration of a station apparatus according to one or more embodiments.

Referring to FIG. 2, the station apparatus 100 comprises a charging circuit 110, a Hall sensor 120, a communication interface 130, a memory 140, a switch 150, and a processor 160.

The charging circuit 110 may convert AC power of an external power source PS into DC power for charging the battery of the robot 200, and may supply the DC power to the robot 200.

The charging circuit 110 may include a rectifier, a direct current-to-direct current converter (DC-DC converter), and a first charging terminal. The rectifier may receive AC power from the external power source PS, convert the AC power into DC power, and output the converted DC power. For example, the rectifier may include a bridge diode converting directions of an AC voltage and an AC current into a positive voltage and a positive current, and a capacitor removing fluctuation of the positive voltage.

The DC-DC converter may change a voltage value of DC power rectified by the rectifier. For example, the DC-DC converter may convert the voltage of the DC power rectified by the rectifier into approximately 24.9 V. Meanwhile, although the above embodiment describes that the station apparatus 100 includes the rectifier and the DC-DC converter, the present disclosure is not limited thereto, and the station apparatus 100 may include a transformer (AC-AC converter), and the rectifier.

When the first charging terminal 114 and the second charging terminal 211 contact each other, the charging circuit 110 may charge the battery of the robot 200.

The first charging terminal may contact the second charging terminal of the robot 200 to charge the battery of the robot 200. Specifically, the first charging terminal may apply a DC voltage output from the DC-DC converter to the second charging terminal of the robot 200.

In addition, the charging circuit 110 may further include a field effect transistor (FET), and when a charging condition is satisfied, the FET may be turned on to supply power to the robot 200 through the charging terminal.

The communication interface 130 may perform communication with an external apparatus. The communication interface 130 may establish a communication connection with a communication interface of the robot 200 while the robot 200 returns to the station apparatus 100. The communication interface 130 may transmit information on whether docking has occurred to the robot 200 under control of the processor 160.

The memory 140 may store data required for operation of the station apparatus 100 according to various embodiments of the present disclosure.

One or more instructions may be stored in the memory 140. Further, programs, applications, and data for operating the station apparatus 100 may also be stored in the memory 140.

The processor 160 controls overall operations of the station apparatus 100. Specifically, the processor 160 may be connected to components of the station apparatus 100 to control overall operations of the station apparatus 100. For example, the processor 160 may control the station apparatus 100 while being connected to the charging circuit 110, a Hall sensor (e.g., a Hall effect sensor) 120, the communication interface 130, the memory 140, and a switch 150. The processor 160 may include one or more processors.

The processor 160 may perform operations of the station apparatus 100 according to embodiments of the present disclosure by executing one or more instructions stored in the memory 140.

According to one or more embodiments of the present disclosure, the processor 160 may control the communication interface 130 to perform a communication connection while the robot 200 returns to the station apparatus 100.

Meanwhile, the configuration illustrated in FIG. 2 is merely one or more embodiments, and various components may be added or omitted depending on a type of the station apparatus 100. For example, the station apparatus 100 may further include at least one of a Hall sensor 120 or a switch 150.

The Hall sensor 120 is a component for detecting that the robot 200 has docked. In particular, the Hall sensor 120 may detect a magnetic field generated by an electromagnet of the robot 200 to detect docking of the robot 200. While the Hall sensor 120 is described as one example of a sensor configured to detect the docked status of the robot 200 at the station apparatus 100, the embodiments of the present disclosure are not limited to this configuration. Other sensor types may be used to achieve the same result. For instance, a contact sensor may be used to detect a connection between metal contact plates of the robot 200 and pins on the station apparatus 100. Alternatively or additionally, an infrared (IR) sensor may be used to detect IR signals transmitted from the robot 200 to confirm docking.

The switch 150 is a component for detecting docking of the robot 200. When the switch 150 is turned on, the station apparatus 100 may control the communication interface 130 to transmit information indicating whether docking has occurred. In this case, the switch 150 may be exposed to the outside in order to detect docking of the robot 200 when the robot 200 docks with the station apparatus 100.

When the robot 200 docks with the station apparatus 100 and the switch 150 is turned on, the processor 160 may control the communication interface 130 to generate information indicating whether docking has occurred and to transmit the information to the robot 200.

When a magnetic field of the electromagnet is detected by the Hall sensor 120, the processor 160 may control the charging circuit 110 to charge the robot 200. In other words, the processor 160 may turn on the FET to charge the robot 200.

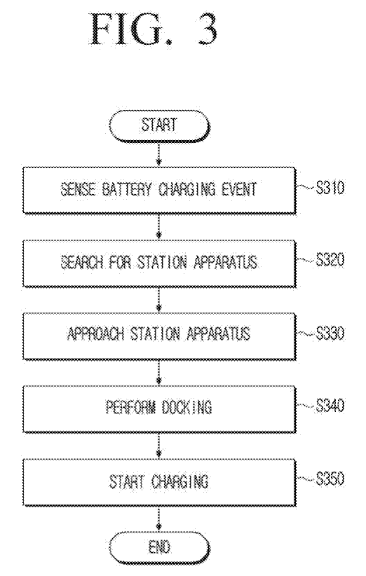

FIG. 3 is a flowchart provided to explain a method in which a robot docks with a station apparatus and charges a battery according to one or more embodiments.

The robot 200 may detect a battery charging event (S310). In this case, the battery charging event may include an event in which a remaining battery level of the robot 200 is less than a threshold value (that is, an event in which an output voltage approaches a minimum voltage), an event in which a user command for returning to the station apparatus 100 is input, and an event related to an operation state of the robot 200.

The robot 200 may search for the station apparatus 100 (S320). In other words, the robot 200 may identify a location of the station apparatus 100 using a map generated through a simultaneous localization and mapping (SLAM) method, and may search for information of the station apparatus 100 using various sensors. In this case, the information of the station apparatus 100 may include shape information of the station apparatus 100, reflection pattern information of the station apparatus 100, and quick response (QR) code information. In other words, the robot 200 may obtain shape information or QR code information of the station apparatus 100 using an image sensor, and may obtain reflection pattern information using a light detection and ranging (LiDAR) sensor. The robot 200 may then travel to return to the station apparatus 100.

The robot 200 may approach the station apparatus 100 (S330). Specifically, the robot 200 may measure a distance between the robot 200 and the station apparatus 100 using various sensors, and may align with the station apparatus 100 using sensing information obtained through a LiDAR sensor or an image sensor.

The robot 200 may travel to a detected position of the station apparatus 100 and move to a position for performing docking with the station apparatus 100.

When the robot 200 moves to the position for performing docking with the station apparatus 100, the robot 200 may perform docking (S340). Here, the docking may refer to an operation in which two objects approach and meet each other by adjusting speed and may be physically connected.

While the robot 200 docks with the station apparatus 100, after a communication connection (or pairing) is performed by a communication interface of the robot 200 (particularly a Bluetooth module), and when the robot 200 docks with the station apparatus 100 and a switch is turned on, the robot 200 may receive information indicating whether docking has occurred from the station apparatus 100. Accordingly, the robot 200 may detect the station apparatus 100 based on the docking information.

The robot 200 may start charging (S350). Specifically, the robot 200 may apply a current to an electromagnet based on detection of the station apparatus 100. When a Hall sensor 120 of the station apparatus 100 detects a magnetic field generated by the electromagnet to which the current is applied, the station apparatus 100 may turn on a field effect transistor (FET) of the charging circuit 110. The robot 200 may start charging using power supplied from the charging circuit 110.

Meanwhile, a method in which the station apparatus 100 and the robot 200 perform docking in step S340 will be described with reference to the following drawings.

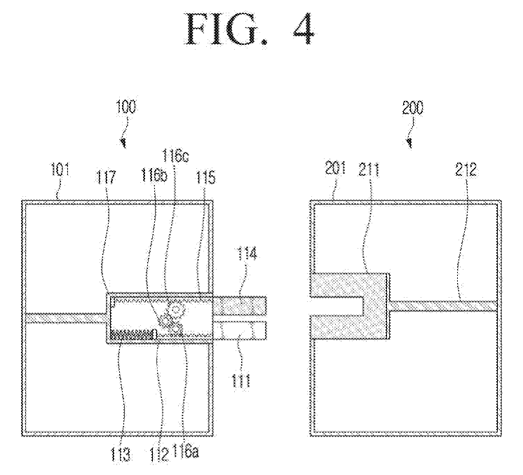

FIG. 4 is a view provided to explain configuration for performing docking between a station apparatus and a robot according to one or more embodiments.

Referring to FIG. 4, the station apparatus 100 may include a protruding member 111 protruding to outside of a first frame 101. The first frame 101 may be a main body forming an exterior of the station apparatus 100 or a portion of the main body.

The protruding member 111 may contact a robot approaching the station apparatus 100 for docking with the station apparatus 100. The protruding member 111 may be an electrically insulating member through which electricity does not flow.

The protruding member 111 may be supported by a first support 112. When the first support 112 moves toward an inside or outside of the first frame 101, the protruding member 111 may move along the first support 112. The first support 112 may be an electrically conductive member.

The first support 112 may be connected to an elastic member 113. The elastic member 113 may provide an elastic force in a direction in which the first support 112 protrudes to an outside of the first frame 101. In other words, the elastic member 113 may provide an elastic force in a direction in which the protruding member 111 protrudes to the outside of the first frame 101. The elastic member 113 may be a spring, but is not limited thereto.

When the station apparatus 100 and the robot 200 are not docked, the protruding member 111 may protrude to the outside of the first frame 101 by the elastic force of the elastic member 113.

The station apparatus 100 may include a first charging terminal 114 for charging the robot 200. The first charging terminal 114 may be connected to a control circuit for controlling an operation of the station apparatus 100. The control circuit may include the processor 160, and may be connected to a charging adapter for charging the robot 200.

The robot 200 may include a second charging terminal 211 for receiving power from the first charging terminal 114 to charge a battery. The second charging terminal 211 may be connected to the battery of the robot 200.

In order for the station apparatus 100 to charge the robot 200, the station apparatus 100 and the robot 200 should be docked such that the first charging terminal 114 and the second charging terminal 211 contact each other.

During a docking process between the station apparatus 100 and the robot 200, movement of the protruding member 111 and movement of the first charging terminal 114 may be interlocked by at least one gear (116a, 116b, 116c).

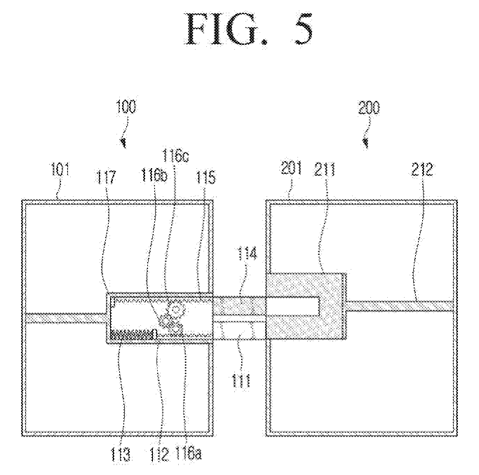

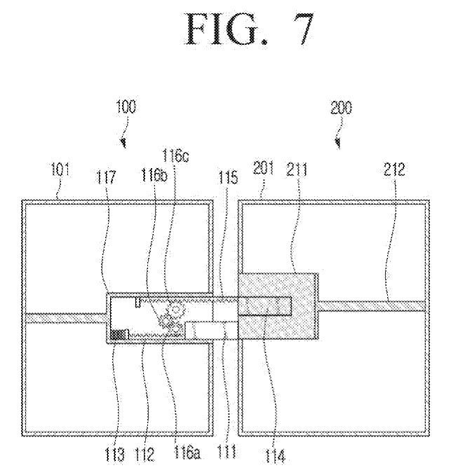

FIGS. 5, 6 and 7 are views provided to explain a docking process between a station apparatus and a robot according to one or more embodiments.

Referring to FIG. 5, before the first charging terminal 114 and the second charging terminal 211 contact each other during docking of the robot 200 with the station apparatus 100, the second charging terminal 211 may first contact the protruding member 111.

When the second charging terminal 211 contacts the protruding member 111, the second charging terminal 211 may push the protruding member 111 from the outside of the first frame 101 toward the inside of the first frame 101.

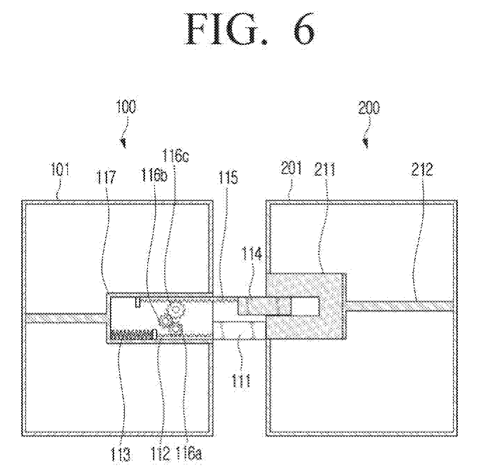

Referring to FIG. 6, the protruding member 111 (or the first support 112 including the protruding member 111) may compress the elastic member 113. At this time, the elastic member 113 may provide an elastic force in a direction pushing the protruding member 111 toward an outside of the first frame 101.

By the elastic force provided by the elastic member 113, the protruding member 111 may provide a force pushing the robot 200 in a direction opposite to a traveling direction of the robot 200. Accordingly, a traveling speed of the robot 200 may decrease.

When the protruding member 111 is retracted into the first frame 101, a first gear 116a engaged with a plurality of first grooves of the first support 112 may rotate in a first direction. Here, the first direction may be a clockwise direction.

A second gear 116b engaged with the first gear 116a may rotate in a second direction opposite to the first direction. Here, the second direction may be a counterclockwise direction.

A third gear 116c engaged with the second gear 116b may rotate in the first direction. Here, the third direction may be a clockwise direction. The first direction may be a direction in which the third gear 116c protrudes the first charging terminal 114 from the inside of the first frame 101 to the outside of the first frame 101.

The third gear 116c may engage with a second support 115 supporting the first charging terminal 114. Specifically, the third gear 116c may engage with a plurality of second grooves included in the second support 115. The second support 115 may be an electrically conductive member.

In this case, when the third gear 116c rotates in the first direction, the first charging terminal 114 may protrude to an outside of the first frame 101 by the third gear 116c. As the second support 115 protrudes to the outside of the first frame 101, the first charging terminal 114 supported by the second support 115 may also protrude together to the outside of the first frame 101. Although FIG. 4 illustrates the second support 115 and the first charging terminal 114 as being separated from each other, the present disclosure is not limited thereto, and the second support 115 and the first charging terminal 114 may be implemented as an integrated structure.

Meanwhile, a degree to which the protruding member 111 reduces a speed of the robot 200 may be determined according to a gear ratio between at least one gear.

For example, when a gear ratio of a first gear 116a, a second gear 116b, and a third gear 116c is 1:1:N, a traveling speed of the robot 200 may be reduced to 1/N.

The second charging terminal 211 of the robot 200 may be implemented in a form including a hole configured to receive the first charging terminal 114.

As illustrated in FIG. 5, as the first charging terminal protrudes to an outside of the first frame 101, the first charging terminal 114 may be received in a hole provided in the second charging terminal 211. Accordingly, the first charging terminal 114 and the second charging terminal 211 may come into contact with each other.

As a degree to which the first charging terminal 114 protrudes to an outside of the first frame 101 increases, an area in which the first charging terminal 114 is received in the hole of the second charging terminal 211 may increase. Accordingly, a contact area between the first charging terminal 114 and the second charging terminal 211 may increase.

As described above, during docking of the robot 200 with the station apparatus 100, the contact area between the first charging terminal 114 and the second charging terminal 211 may gradually increase.

Accordingly, a problem in which static electricity charged on the second charging terminal 211 is rapidly introduced to the first charging terminal 114 through the first charging terminal 114 may be prevented. In other words, as a contact area between the first charging terminal 114 and the second charging terminal 211 gradually increases, the static electricity charged on the second charging terminal 211 may be gradually introduced to the first charging terminal 114.

Referring to FIG. 6, when the first charging terminal 114 is fully received in the hole of the second charging terminal 211, docking between the station apparatus 100 and the robot 200 may be completed.

Specifically, when a contact area between the first charging terminal 114 and the second charging terminal 211 becomes greater than or equal to a preset value, the station apparatus 100 may charge the robot 200.

When docking between the station apparatus 100 and the robot 200 is completed, the station apparatus 100 may charge the robot 200 through the first charging terminal 114.

Meanwhile, the station apparatus 100 may include a first ground member 117 for receiving static electricity introduced from the second charging terminal 211 to the first charging terminal 114. The first ground member 117 may be an electrically conductive member.

Specifically, the first ground member 117 may be connected to the first charging terminal 114 such that a potential difference occurs between the first charging terminal 114 and the first ground member 117. Accordingly, static electricity introduced through the first charging terminal 114 may move to the first ground member 117.

The first ground member 117 may be connected to the first frame 101 forming at least a portion of the station apparatus 100. The static electricity received in the first ground member 117 may be discharged to the first frame 101.

Accordingly, static electricity introduced to the first charging terminal 114 through the second charging terminal 211 may be discharged to the first frame 101 through the first ground member 117 without entering a circuit of the station apparatus 100.

Specifically, while a contact area between the first charging terminal 114 and the second charging terminal 211 gradually increases, static electricity generated by friction between the robot 200 and a floor surface may be introduced from the second charging terminal 211 to the first charging terminal 114. The static electricity introduced to the first charging terminal 114 may be discharged to the first frame 101 through the first ground member 117.

In addition, while the contact area between the first charging terminal 114 and the second charging terminal 211 gradually increases, static electricity generated by friction between the first charging terminal 114 and the second charging terminal 211 may be discharged to the first frame 101 through the first ground member 117.

Specifically, static electricity introduced through the first charging terminal 114 or static electricity generated at the first charging terminal 114 may be introduced to the first ground member 117 along the second support 115. The static electricity introduced to the first ground member 117 may be discharged to the first frame 101.

Further, the robot 200 may include a second ground member 212 configured to receive static electricity charged on the second charging terminal 211. The second ground member 212 may be a conductor through which electricity is capable of flowing.

The static electricity introduced through the second charging terminal 211 may be received in the second ground member 212.

The second ground member 212 may be connected to the second frame 201. The static electricity received in the second ground member 212 may be discharged to the second frame 201.

As static electricity generated in the robot 200 is discharged to the second ground member 212 included in the robot 200, static electricity flowing into the first charging terminal 114 may be reduced.

Meanwhile, in order to reduce a rate at which the contact area between the first charging terminal 114 and the second charging terminal 211 increases, the station apparatus 100 may control an approach speed at which the robot 200 approaches the station apparatus 100.

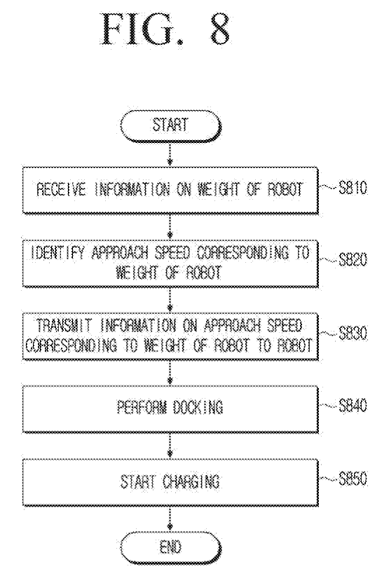

FIG. 8 is a flowchart provided to explain a method in which the station apparatus 100 controls an approach speed of the robot 200 according to one or more embodiments.

Referring to FIG. 8, the station apparatus 100 may receive information on a weight of the robot 200 from the robot 200 (S810).

The weight of the robot 200 may include a weight of a load mounted on the robot 200. When the robot 200 is a cleaning robot, the load may include at least one of a weight of a mop, collected dust or debris, or a cleaning liquid.

The station apparatus 100 may control the robot 200 such that an approach speed decreases as the weight of the robot 200 increases.

When the information on the weight of the robot 200 is received, the station apparatus 100 may identify an approach speed corresponding to the weight of the robot 200 (S820).

For example, the memory 140 may store information on approach speeds according to weights of the robot 200 in a lookup table form. The station apparatus 100 may identify the approach speed corresponding to the weight using the lookup table stored in the memory 140.

The station apparatus 100 may transmit information on the approach speed corresponding to the weight of the robot 200 to the robot 200 so that the robot 200 approaches and docks with the station apparatus 100 at the corresponding approach speed (S830).

When the robot 200 approaches the station apparatus 100 at the received approach speed and contacts the station apparatus 100, docking may be performed (S840).

The docking process between the station apparatus 100 and the robot 200 may be the same as described with reference to FIGS. 4 to 6.

When docking between the station apparatus 100 and the robot 200 is completed, the station apparatus 100 may start charging the robot 200 (S850).

Although various embodiments have been respectively described above, each embodiment is not necessarily implemented independently, and at least one embodiment may be wholly or partially combined with at least one other embodiment and implemented together in a single product.

Meanwhile, the term “unit” or “module” used in the present disclosure includes a unit configured with hardware, software, or firmware, and may be interchangeably used with terms such as logic, a logic block, a component, or a circuit. The “unit” or “module” may be a component configured as an integrated element or may be a minimum unit or a portion thereof that performs one or more functions. For example, the module may be configured as an application-specific integrated circuit (ASIC).

The above-described various embodiments may be implemented as software including instructions stored in machine-readable storage media, which can be read by machine (e.g.: computer). The machine refers to a device that calls instructions stored in a storage medium, and can operate according to the called instructions, and may include an electronic apparatus 100 according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

According to one or more embodiments, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore^{TM}). In case of the online distribution, at least a portion of the computer program product may be at least temporarily stored in a storage medium such as a memory of a server of a manufacturer, a server of an application store, or a relay server or be temporarily generated.

In addition, the components (for example, modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, or at least some of the operations may be performed in a different order or be omitted, or other operations may be added.

What is claimed is:

1. A station apparatus for charging a robot, the station apparatus comprising:
a frame;
a protruding member protruding from the frame; and
a charging circuit comprising a first charging terminal,
wherein, based on the robot contacting the protruding member, the protruding member is retracted into the frame and reduces a traveling speed of the robot;
wherein, as the protruding member is retracted into the frame, the first charging terminal moves from a first position inside the frame to a second position outside the frame, and
wherein, as the first charging terminal protrudes from the first position to the second position, a contact area between the first charging terminal and a second charging terminal of the robot increases.

2. The station apparatus of claim 1, further comprising:
at least one gear configured to move the first charging terminal to the second position outside the frame as the protruding member is retracted into the frame.

3. The station apparatus of claim 2, wherein the at least one gear comprises:
a first gear configured to rotate in a first direction as the protruding member is retracted into the frame;
a second gear configured to rotate in a second direction opposite to the first direction as the first gear rotates; and
a third gear configured to rotate in the first direction as the second gear rotates and move the first charging terminal to the second position outside the frame.

4. The station apparatus of claim 3, further comprising:
a first support that supports the protruding member,
wherein the first support comprises a plurality of first grooves; and
wherein the first support engages with the first gear through the plurality of first grooves.

5. The station apparatus of claim 3, further comprising:
a second support that supports the first charging terminal,
wherein the second support comprises a plurality of second grooves; and
wherein the second support engages with the third gear through the plurality of second grooves.

6. The station apparatus of claim 3, wherein the protruding member is configured to reduce the traveling speed of the robot at a speed corresponding to a gear ratio between the first gear and the third gear.

7. The station apparatus of claim 1, further comprising:
an elastic member configured to provide an elastic force to move the protruding member to the second position outside the frame,
wherein, based on the protruding member moving in a direction compressing the elastic member, the traveling speed of the robot is reduced by the elastic force.

8. The station apparatus of claim 1, further comprising:
an elastic member configured to provide an elastic force to move the protruding member to the second position outside the frame,
wherein, based on the robot moving away from the station apparatus, the protruding member protrudes to the second position outside the frame by the elastic force.

9. The station apparatus of claim 1, wherein, while the contact area between the first charging terminal and the second charging terminal increases, static electricity generated by friction between the robot and a floor surface is introduced from the second charging terminal to the first charging terminal.

10. The station apparatus of claim 1, further comprising:
a ground member configured to receive static electricity introduced through the first charging terminal from the second charging terminal,
wherein, while the contact area between the first charging terminal and the second charging terminal increases, the static electricity introduced through the first charging terminal from the second charging terminal moves to the ground member.

11. The station apparatus of claim 10, wherein the static electricity moved to the ground member is discharged to the frame.

12. The station apparatus of claim 1, wherein the second charging terminal comprises a hole for receiving the first charging terminal; and
wherein, based on the first charging terminal protruding to the second position outside the frame, at least a portion of the first charging terminal is received in the hole.

13. The station apparatus of claim 1, wherein, based on an area in which the first charging terminal and the second charging terminal contact each other becoming greater than or equal to a preset value, the robot is charged.

14. The station apparatus of claim 1, wherein the first charging terminal and the second charging terminal are electrically conductive, and
wherein the protruding member is electrically insulating.

15. The station apparatus of claim 1, further comprising:
memory; and
at least one processor,
wherein the at least one processor is configured to:
receive information on a weight of the robot from the robot,
identify an approach speed corresponding to the weight of the robot, and
transmit information on the approach speed corresponding to the weight of the robot to the robot so that the robot approaches and docks with the station apparatus at the identified approach speed.

16. A method of controlling a station apparatus for charging a robot, the method comprising:
based on the robot contacting a protruding member protruding from a frame of the station apparatus, retracting the protruding member into the frame to reduce a traveling speed of the robot;
protruding, as the protruding member is retracted into the frame, a first charging terminal of a charging circuit from an inside of the frame to an outside of the frame; and
increasing, as the first charging terminal protrudes to the outside of the frame, a contact area between the first charging terminal and a second charging terminal of the robot.

17. The method of claim 16, wherein the retracting of the protruding member and the protruding of the first charging terminal are interlocked by at least one gear of the station apparatus.

18. The method of claim 16, further comprising:
while the contact area between the first charging terminal and the second charging terminal increases, receiving, at a ground member of the station apparatus, static electricity introduced through the first charging terminal from the second charging terminal.

19. The method of claim 16, further comprising:
receiving information on a weight of the robot from the robot;
identifying an approach speed corresponding to the weight of the robot; and
transmitting information on the approach speed corresponding to the weight of the robot to the robot so that the robot approaches and docks with the station apparatus at the identified approach speed.

20. A non-transitory computer-readable storage medium storing one or more instructions that, when executed by at least one processor of a station apparatus for charging a robot, cause the station apparatus to perform the method of claim 16.
